(19) United States
(12) Patent Application Publication
(10) Pub. No.: US 2026/0368676 A1
(43) Pub. Date: Nov. 19, 2026

(54) USAGE RECOMMENDATIONS FOR COMPUTING DEVICES BASED ON COMPUTING DEVICE ENERGY CONSUMPTION

(71) Applicant: Honeywell International Inc., Charlotte, NC (US)

(72) Inventors: Sandhya Beejady, Bengaluru (IN); Rajapriyan Thambidurai, Bengaluru (IN); Sridhar Sankaranarayanan, Bengaluru (IN)

(21) Appl. No.: 19/207,834

(22) Filed: May 14, 2025

(51) Int. Cl. G06Q 10/0637; G06Q 10/0639

(52) U.S. Cl. CPC G06Q 10/0637; G06Q 10/0639

(57) ABSTRACT

Generating usage recommendations for computing devices based on computing device energy consumption is described herein. One method includes identifying a plurality of computing devices associated with an organization, determining a computing resource usage value for each of the plurality of computing devices, determining a corresponding computing resource provider for each of the plurality of computing devices, calculating a power usage value for each of the corresponding computing resource providers by the plurality of computing devices, determining an emission value for the organization based on the power usage value for each of the corresponding computing resource providers and emission statistics for each of the corresponding computing resource providers, and generating a usage recommendation for the organization to alter the emission value based on the computing resource usage value for each of the plurality of computing devices and the corresponding computing resource provider for each of the plurality of computing devices.

### TECHNICAL FIELD

The present disclosure relates generally to devices, methods, and systems for generating usage recommendations for computing devices based on computing device energy consumption.

### BACKGROUND

Organizations can be required to report their greenhouse gas (GHG) emissions to government agencies to ensure transparency and compliance with environmental regulations. They typically report emissions in three categories: Scope 1 (direct), Scope 2 (indirect from energy), and sometimes Scope 3 (value chain-related). This data is submitted through standardized frameworks such as the United States Environmental Protection Agency's (EPA's) Greenhouse Gas Reporting Program or the European Union's Emissions Trading System. Accurate reporting helps governments track national climate goals and may impact carbon pricing, permits, or sustainability ratings.

### BRIEF DESCRIPTION OF THE DRAWINGS

FIG. 1 illustrates an example of a method for generating usage recommendations for computing devices based on computing device energy consumption in accordance with one or more embodiments.

FIG. 2 illustrates an example of a system for generating usage recommendations for computing devices based on computing device energy consumption in accordance with one or more embodiments.

FIG. 3 illustrates an example of a system for generating usage recommendations for computing devices based on computing device energy consumption in accordance with one or more embodiments.

FIG. 4 is an example of a computing device for generating usage recommendations for computing devices based on computing device energy consumption in accordance with one or more embodiments.

### DETAILED DESCRIPTION

Devices, methods, and systems for generating usage recommendations for computing devices based on computing device energy consumption are described herein. One method includes identifying, by a computing device, a plurality of computing devices associated with an organization, determining, by the computing device, a computing resource usage value for each of the plurality of computing devices, determining, by the computing device, a corresponding computing resource provider for each of the plurality of computing devices, calculating, by the computing device, a power usage value for each of the corresponding computing resource providers by the plurality of computing devices, determining, by the computing device, an emission value for the organization based on the power usage value for each of the corresponding computing resource providers and emission statistics for each of the corresponding computing resource providers, and generating, by the computing device, a usage recommendation for the organization to alter the emission value based on the computing resource usage value for each of the plurality of computing devices and the corresponding computing resource provider for each of the plurality of computing devices.

The present disclosure relates to generating usage recommendations utilizing an emission management component. In some embodiments, the emissions management component can utilize or be executed by a Software as a Service (SaaS) to compute energy consumption for emission accounting to provide a holistic report for the different scopes of emissions reporting for various organizations. For example, an organization can generate a report for direct emissions (scope 1), indirect emissions from energy (scope 2), and indirect emissions from value chain (scope 3). It can be relatively straight forward to report direct emissions for an organization that utilizes a plurality of computing devices. For example, an organization can report the electrical power utilized by the computing device or other electrical devices within an office and provide information about the electrical provider.

However, it can be more difficult for an organization to report indirect emissions from energy and indirect emissions from value chain. For example, an organization can utilize cloud computing resources. Cloud computing resources can be provided by servers that are located at different geographical locations. In addition, the organization can utilize a plurality of different cloud resource providers (e.g., server farms, data centers, computing resource providers, etc.) that are geographically located in different parts of the world. In some situations, the cloud resource providers can each utilize a different electrical provider. Each geography or country in which data centers of cloud providers reside will use energy that will use it's corresponding emission factors as identified for that geography or energy supplier. In this way, it can be difficult to monitor or report on emissions associated with the cloud computing providers.

The present disclosure can utilize the emission management component to monitor transactions between computing devices of an organization and the cloud resource providers. In some embodiments, the emission management component can be part of the SaaS or cloud resource provided by the cloud resource provider. The quantity of transactions can be utilized to determine the quantity of computing resources utilized by the computing devices of the organization. In this way, compute transactions for each of a plurality of computing devices of the organization can be utilized to determine a quantity of computing resources utilized by the plurality of computing devices from a plurality of different cloud resource providers. In these examples, the electrical providers for the different cloud resource providers can be analyzed to determine emissions per electrical usage unit (e.g., kilowatt-hours, etc.).

In this way, a quantity of kilowatt-hours utilized by computing devices performing transactions with the cloud computing providers can be determined and the emissions per kilowatt-hours for the electrical provider utilized by the cloud resource providers can be determined based on emissions statistics of the electrical provider. In this way, the emissions per kilowatt-hour of the electrical provider to the computing resource provider can be utilized to calculate the emissions utilized by the computing devices for the organization over a period of time.

In some embodiments, the emissions per kilowatt-hour can be different for each electrical provider. For example, a first electrical provider can utilize a first percentage of non-emissions power (e.g., solar power, wind power, hydroelectric power, etc.) and a second percentage of emissions power (e.g., carbon emitting power, natural gas, coal, oil, etc.) and a second electrical provider can utilize a second percentage of non-emissions power and a second percentage of emissions power. In this example, the first electrical provider can have greater emissions per kilowatt-hour than the second electrical power provider when the first percentage of emissions power is greater than the second percentage of emissions power.

Further, a usage report can be generated for the organization such that the organization can report on emissions for the indirect energy usage of the organization (e.g., energy used by the computing resource provider to provide services to the organization, etc.). The usage report can also include recommendations for altering the usage patterns of the plurality of computing devices. For example, the computing devices can utilize the cloud resources to execute machine learning models. In this example, the execution of particular machine learning models can be altered to a time period that can lower cost and/or emissions for the organization. In addition, the usage report can help the organization when buying carbon credits or performing other emission reduction techniques.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

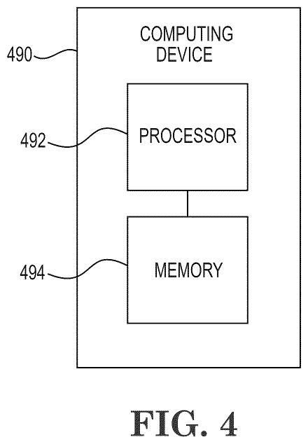

The figures herein follow a numbering convention in which the first digit or digits correspond to the drawing figure number and the remaining digits identify an element or component in the drawing. Similar elements or components between different figures may be identified by the use of similar digits. For example, 490 may reference element “90” in FIG. 4, and a similar element may be referenced as 490 in FIG. 5.

As used herein, “a”, “an”, or “a number of” something can refer to one or more such things, while “a plurality of” something can refer to more than one such things. For example, “a number of components” can refer to one or more components, while “a plurality of components” can refer to more than one component.

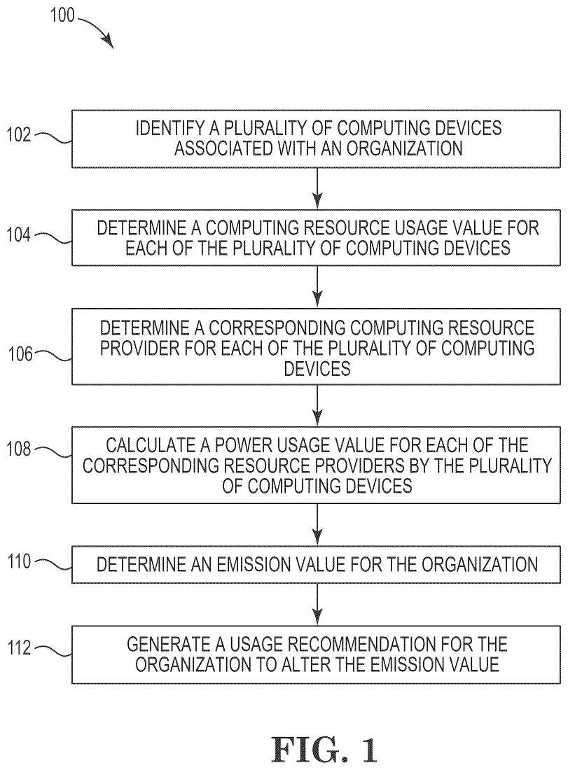

FIG. 1 illustrates an example of a method for generating usage recommendations for computing devices based on computing device energy consumption in accordance with one or more embodiments. The method 100 can be performed by, for example, computing device 490, further described in connection with FIG. 5.

In some embodiments, the method 100 can be executed as part of a System as a Service (SyaaS) or a software as a service (SaaS). As used herein, a SyaaS can deliver a complete computing system as a service whereas a SaaS can provide a particular application or portion of a computing system. For the purposes of this application, the SyaaS and SaaS can be utilized interchangeably. For example, the usage recommendation can be provided for computing devices that utilize a SyaaS and/or computing devices that utilize particular SaaS. In both of these examples, the computing device is receiving a service from a computing resource provider.

In other embodiments, the method 100 can be executed by a remote computing device that monitors the SaaS or computing devices that utilize the SaaS. In this way, the method 100 can be utilized to generate usage recommendations for a plurality of computing devices that are located at different geographical locations around the world. For example, the method 100 can be utilized to determine emission reports (e.g., direct emissions (scope 1) reports, indirect emissions from energy (scope 2) reports, and indirect emissions from value chain (scope 3) reports, etc.). for an organization that utilizes the SaaS at different geographic locations.

At 102, the computing device can identify a plurality of computing devices associated with an organization. In some examples, the plurality of computing devices can be personal computers utilized by employees or members of the organization. In this way, the plurality of computing devices can be located a plurality of different geographic locations when being utilized by different users. As described herein, a plurality of computing devices utilized at a plurality of different geographic locations can be difficult to monitor when generating emissions reports. For example, indirect emissions from energy (scope 2) reports can be difficult to calculate when the plurality of computing devices are located at different geographic locations and/or utilize different computing resource providers (e.g., cloud resource provider, server, etc.) to provide a SaaS.

In a specific example, a first computing device associated with the organization can be located at a first geographical location and utilize a SaaS from a first computing resource provider that receives electrical power (e.g., electricity, etc.) from a first electrical provider. In this example, the organization can also include a second computing device that is located at a second geographical location and utilize the SaaS from a second computing resource provider that receives electrical power from a second electrical provider.

In this example, the first computing device and the second computing device can utilize different quantity of computing resources when utilizing the SaaS. In addition, the first computing resource provider and the second computing resource provider can utilize different quantities of electricity when providing the computing resources for the SaaS. Further, the first electrical provider and the second electrical provider can each utilize different ratios of renewable energy resources and carbon emission resources. Thus, the first computing device and the second computing device can have vastly different emission reports even when the first computing device and the second computing device utilize the SaaS in the same or similar way.

At 104, the computing device can determine a computing resource usage value for each of the plurality of computing devices. In some embodiments, the computing resource usage value can refer to a quantity of computing resources utilized by a particular computing device. For example, a particular request to a SaaS can result in a particular quantity of computing resources needed to complete the particular request.

The computing resource usage value can refer to a quantity of processing resources (e.g., CPU utilization, etc.), memory resources (e.g., RAM utilization, etc.) and/or network resources (e.g., network interface utilization, etc.) that is utilized by the computing resource provider when performing a particular task for one of the plurality of computing devices. Although specific resources are described herein, other resources can be utilized to determine the computing resource value. For example, the computing resource value can correspond to an electrical usage value needed by the computing resource provider to perform a particular function and provide the function to the computing device.

In some embodiments, the method 100 can be executed to determine time stamp data of the computing resource usage values for each of the plurality of computing devices. In some embodiments, the time stamp data can be utilized to identify a time and date when the computing resources were utilized by a particular computing device. As described herein, an electrical provider can utilize different types of resources to generate electricity. In some cases, the electrical provider can utilize more renewable energy during different times of the year and/or different times of a particular day. In this way, the time stamp data can be utilized to correlate a ratio of renewable energy and carbon emission energy utilized when the computing resources were provided to a particular computing device.

Thus, in these embodiments, the time stamp data indicates a time when the computing resource usage values were performed by each of the computing devices. In these embodiments, the emission statistics for each of the corresponding computing resource providers includes a quantity of emissions released by an electrical provider for a plurality of time windows. That is, the emissions statistics for the electrical provider can be utilized with the time stamp data to identify time windows when the computing resources were utilized and when the electrical resources were provided to the computing resource provider. In this way, a emission statistics can be reflected for the particular time the resources were provided to the plurality of computing devices.

In some embodiments, the method 100 can be executed to identify the computing resource usage values for the plurality of time windows based on the time stamp data. As described herein, the plurality of time windows can reflect time periods when the computing resources were utilized by the plurality of computing devices or by a particular computing device. In some embodiments, the plurality of windows can include a quantity of computing resources utilized during the plurality of windows. In this way, the plurality of windows can be utilized to determine a quantity of electrical resources utilized by the computing resource providers and since the windows also include the date and/or time stamp data, the emissions statistics for the corresponding windows can be utilized to generate the emissions report.

In some embodiments, the method 100 can be executed to generate an individual usage recommendation for each of the plurality of computing devices to increase future computing resource usage values to include future time stamp data within time windows of the plurality of time windows that include a quantity of emissions below threshold quantity of emissions. In some embodiments, the individual usage recommendation for each of the plurality of computing devices can be directed to lower the quantity of emissions utilized by each of the quantity of computing devices. In other embodiments, the individual usage recommendations can include recommendations for lower a cost of the computing resources utilized by each of the plurality of computing devices. Thus, the individual usage recommendations can include instructions or recommendations for altering usage of a computing device to lower emissions, energy usage, and/or cost associated with utilizing the computing device.

In some embodiments, the computing resource usage value identifies a quantity of compute transactions between a computing device of the plurality of computing devices and a particular computing resource provider. As used herein, compute transactions refer to an execution of operations on a computing system that involve processing input data to produce output, often using central processing unit (CPU) or graphic processing unit (GPU) resources. These transactions may include arithmetic calculations, logic operations, memory access, or running applications and services, and are typically tracked and managed by the operating system. The efficiency and speed of compute transactions depend on system architecture, available hardware resources, and software optimization. Tracking these different compute transactions can allow the electrical usage to be calculated. For example, each type of compute transaction can correspond to a particular quantity of electricity utilized. In this example, the quantity and types of compute transactions can be utilized to calculate the quantity of electricity utilized by the device that requested the quantity and types of compute transactions from a SaaS.

At 106, the computing device can determine a corresponding computing resource provider for each of the plurality of computing devices. As used herein, a computing resource provider can refer to a provider of a SaaS. For example, can refer to a particular computing resource provider location (e.g., geographic location of a server providing the SaaS, etc.). In this way, the computing resource provider can refer to a particular server or device that is performing the compute transactions for the plurality of computing devices. The computing resource provider can also refer to a general location of a server farm or data center that provides the compute transactions for the plurality of computing devices.

At 108, the computing device can calculate a power usage value for each of the corresponding computing resource providers by the plurality of computing devices. As used herein, the power usage value can refer to a quantity of power or electricity utilized by the computing resource providers to provide the computing resources and/or compute transactions to the plurality of computing devices. In this way, the power usage value can refer to a quantity of power required to provide the SaaS to the plurality of computing devices during the time windows that the plurality of computing devices were utilizing the SaaS.

In some embodiments, the method 100 can be executed to determine an electrical usage for each of the quantity of compute transactions between the computing device of the plurality of computing devices and the particular computing resource provider. In this way, the electrical usage can be calculated for each of the plurality of computing devices based on the quantity of compute transactions requested by each of the plurality of computing devices.

At 110, the computing device can determine an emission value for the organization based on the power usage value for each of the corresponding computing resource providers and emission statistics for each of the corresponding computing resource providers. The emission value can be a quantity of emissions generated by the plurality of computing devices associated with the organization. In some embodiments, the emission value can be an emissions report for the organization that can include the direct and indirect emissions associated with the plurality of computing devices.

In some embodiments, the method 100 can be executed to identify a geographical location of the plurality of computing devices and determine the electrical provider for the corresponding computing resource providers based on the geographical location. In some embodiments, the geographical location of the plurality of computing devices can be utilized to determine a particular computing resource provider that is providing a SaaS and/or providing the computing resources to the computing devices. That is, a current geographic location can affect which of a plurality of computing resource providers are providing the compute transactions to a particular computing device.

In a similar way, the particular computing resource provider that is providing the compute transactions and/or the SaaS to the plurality of computing devices can utilize a particular electrical provider. Thus, the particular computing resource provider can be utilized to determine a corresponding electrical provider and the emissions statistics of the corresponding electrical provider can be utilized to determine the emissions reports for the computing devices that utilize the particular computing resource provider.

At 112, the computing device can generate a usage recommendation for the organization to alter the emission value based on the computing resource usage value for each of the plurality of computing devices and the corresponding computing resource provider for each of the plurality of computing devices. As described herein, the usage recommendation refers to recommendations for altering usage of the computing device and/or computing devices associated with the organization. In some embodiments, the usage recommendation can be based on the emissions statistics of the electrical provider that is providing electricity to the computing resource provider associated with a particular computing device. For example, the usage recommendation can provide different time windows for executing compute transactions such that the emissions or cost associated with the compute transactions is lower. In this way, the usage recommendation can be generated to lower the emissions reports for the plurality of computing devices without having to lower a total quantity of compute transactions.

In some embodiments, the usage recommendation includes instructions for executing future compute transactions during a time period to lower a financial cost to the organization. As described herein, different time periods and/or different time windows can be associated with different financial costs and/or different emissions statistics for the electrical providers, which can correspond to different emissions generation by the plurality of computing devices. In these embodiments, a plurality of designated time windows can be provided to identify particular time windows that can lower the emissions generated by particular computing devices. In some embodiments, the usage recommendation can include avoidance time windows that can identify particular time windows that can increase the emissions generated by particular computing devices. In this way, particular compute transactions can be executed during the designated time windows and/or not executed during the avoidance time windows to lower emissions reports for a particular computing device.

In some embodiments, the method 100 can be executed to provide a personal usage recommendation to each of the plurality of computing devices based on an individual impact to the emission value. As used herein, the individual impact to the emission value can refer to a particular emission value associated with a particular computing device and how the particular emission value impacted a total emission value. In some embodiments, the method 100 can be executed to alter settings of the plurality of computing devices to alter the computer resource usage values.

In some embodiments, the settings of the plurality of computing devices can alter performance of the plurality of computing devices based on the usage recommendation. For example, the settings of the plurality of computing devices can place hold times on particular compute transactions such that the particular compute transactions are executed during designated time windows. Other settings associated with the plurality of computing devices can be altered to increase power usage during designated time windows and lower power usage during avoidance time windows.

In some embodiments, the method 100 can be executed to alter settings of the plurality of computing devices to alter a time window for performing particular computing tasks to alter the computer resource usage values during the time window. As described herein, the settings can be altered to increase performance during time windows with lower emissions per compute transaction and decrease performance during time windows with higher emissions per compute transactions. In this way, the computing devices can perform the same quantity of compute transactions and generate a lower quantity of emissions.

In other embodiments, the settings can be altered to utilize lower compute intensive processes during particular time windows. For example, some machine learning models can utilize a greater quantity of compute resources and/or electricity compared to other machine learning models. In this way, the settings of the computing devices and/or settings of the SaaS can be altered to utilize lower power consuming machine learning models during time windows with a greater electricity cost or greater emissions generation.

In some embodiments, the method 100 can be executed to determine an emission profile and a cost profile for the electrical providers during a period of time. In some embodiments, the method 100 can be executed to determine a first plurality of time windows where the emission profile or the cost profile is above a threshold and a second plurality of time windows where the emission profile or the cost profile is below the threshold. In some embodiments, the first plurality of time windows can be avoidance time windows and the second plurality of time windows can be designated time windows. In this way, the usage recommendations can include settings or usage patterns to increase the quantity of compute transitions to be executed during the second plurality of time windows and/or decrease the quantity of compute transactions executed during the first plurality of time windows.

In some embodiments, the method 100 can be executed to generate the usage recommendation to increase a quantity of computing resource usage value for each of the plurality of computing devices during the second plurality of time windows and decrease a quantity of computing resource usage value for each of the plurality of computing devices during the first plurality of time windows.

In some embodiments, the method 100 can be executed to determine a type of transaction for the plurality of transactions, calculate a power usage value for the type of transaction for the plurality of transactions, and generate a transaction report that identifies a type of transaction to alter based on the power usage value. As described herein, the type of compute transactions can each have a different electricity usage and/or emissions generated. In this way, the type of transactions can be altered to lower the quantity of emissions generated by a particular computing device and/or by the plurality of computing devices.

In some embodiments, the method 100 can be executed to generate financial cost trends and emission trends for the organization based on historical data associated with the plurality of computing devices. The financial cost trends and/or emission trends for the organization can be how the financial costs or emissions have changed over time. These types of trends can be utilized to determine how previous changes to usage patterns and/or settings have affected the financial cost and/or emissions generated by the organization.

In some embodiments, the method 100 can be executed to generate a recommendation for paying carbon taxes based on the emission value for the organization. Paying carbon taxes can alleviate an organization's emissions reporting. In some embodiments, the method 100 can determine a quantity of carbon taxes to pay for the organization based on the emission report for the plurality of computing devices. In some embodiments, the method 100 can be executed to receive emission goals or current standards and utilize the goals or standards to determine a quantity of carbon taxes to pay.

In some examples, the method 100 can provide an emission factor repository and provide the ability to read cloud provider energy consumption for each compute transaction, provide emission accounting, provide auditing and reporting and can utilize a sophisticated energy consumption into the emission accounting of an organization. In some examples, a user interface can be viewed dimensionally for a user level, a site level, an enterprise level based on activities in the system.

Advanced intelligence can be built to identify where and how compute energy can be optimized by the organization in their day-to-day usage of software (e.g., cloud resources, SaaS, etc.). For example, the compute energy for the organization can be performed utilizing recalculation limits, avoiding multiple file processing, reporting generation, identifying edge system downtime due to site maintenance can be optimized to avoid recalculation in the system, among other optimizations.

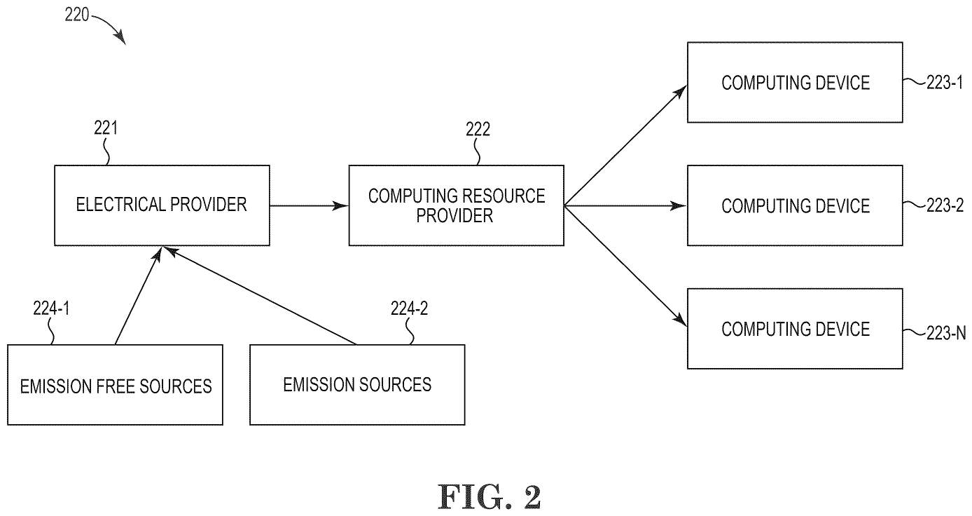

FIG. 2 illustrates an example of a system 220 for generating usage recommendations for computing devices based on computing device energy consumption in accordance with one or more embodiments. The system 220 can illustrate how a plurality of computing devices (e.g., computing device 223-1, computing device 223-2, computing device 223-N, etc.) can receive computing resources from a particular computing resource provider 222.

As illustrated by the system 220, the computing resource provider 222 can receive electricity (e.g., power, electrical power, etc.) from an electrical provider 221. The electrical prodder can be a power company that can distribute electricity to a plurality of entities. The electrical provider 221 can utilize power generated by a plurality of sources (e.g., emission free sources 224-1, emission sources 224-2, etc.). As described herein, the electrical provider 221 can generate electricity utilizing emission free sources 224-1 and emission sources 224-2.

As used herein, emission free sources 224-1 can refer to electricity generating techniques that do not generate emissions such as, but not limited, to carbon dioxide. For example, emission-free electricity generators can produce power without releasing greenhouse gases or other pollutants into the atmosphere. These systems typically include renewable energy technologies such as solar panels, which convert sunlight into electricity using photovoltaic cells, and wind turbines, which harness kinetic energy from the wind. Hydropower is another common source, utilizing the flow of water to spin turbines and generate electricity without burning fossil fuels. Emerging technologies like advanced geothermal systems also aim to deliver clean energy with zero direct emissions.

In contrast, the emission sources 224-2 can utilize generators that generate greenhouse gas emissions when generating the electricity. These sources generate electricity primarily through the combustion of fossil fuels such as coal, natural gas, and/or oil. When these fuels are burned to produce heat, which then generates steam to drive turbines, they emit carbon dioxide (CO₂), nitrogen oxides (NOₓ), sulfur dioxide (SO₂), and particulate matter into the atmosphere. Coal-fired power plants are typically the highest emitters, while natural gas is comparatively cleaner but still contributes significantly to carbon emissions.

As described herein, the electrical provider 221 can provide emissions statistics that illustrate a quantity of emissions per watt of electricity generated for a plurality of time windows. These emissions statistics can be based on the quantity and type of emission free sources 224-1 and/or the quantity and type of emission sources 224-2. The ratio and/or type of these sources can contribute to the emission statistics and can be very different when comparing a first electrical provider and a second electrical provider.

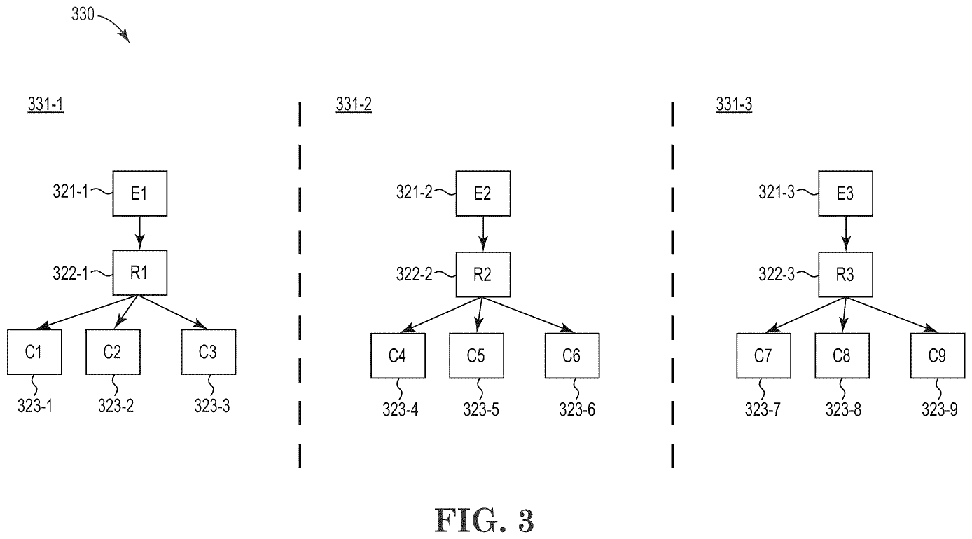

FIG. 3 illustrates an example of a system 330 for generating usage recommendations for computing devices based on computing device energy consumption in accordance with one or more embodiments. In some embodiments, the system 330 illustrates how an organization can utilize a plurality of different computing devices at a plurality of different geographic locations (e.g., first geographic area 331-1, second geographic area 331-2, third geographic area 331-3). In some embodiments, the system 220 as illustrated in FIG. 2 can represent each of the systems at the different geographic locations.

In some embodiments, an organization can utilize a first computing device 323-1, a second computing device 323-2, and a third computing device 323-3 in the first geographic location 331-1. Although three computing devices are illustrated, a greater number of computing devices can be utilized in a similar way. In some embodiments, the first computing device 323-1, the second computing device 323-2, and/or the third computing device 323-3 can receive computing resources from a first computing resource provider 322-1. For example, the first computing resource provider 322-1 can provide a SaaS, cloud resource, or other types of computing resources to the first computing device 323-1, the second computing device 323-2, and/or the third computing device 323-3.

As described herein, the first computing resource provider 322-1 can receive electricity from a first electrical provider 321-1. The first electrical provider 321-1 can utilize different types of electricity generations. For example, the first electrical provider 321-1 can utilize a particular quantity of emission free sources and a particular quantity of emission sources. In addition, the first electrical provider 321-1 can utilize particular types of emission free sources and particular types of emission sources. These different types of electricity sources can contribute to the emission statistics of the first electrical provider 321-1.

As described herein, the first computing device 323-1, the second computing device 323-2, and/or the third computing device 323-3 can each utilize a corresponding quantity of computing resources from the first computing resource provider 322-1 during corresponding time windows. In this way, an emission report can be generated for the first computing device 323-1, the second computing device 323-2, and/or the third computing device 323-3 utilizing the corresponding consumed computing resources and emission statistics of the first electrical provider 321-1.

In a similar way, the organization can include a fourth computing device 323-4, a fifth computing device 323-5, and/or a sixth computing device 323-6 that are geographically located within the second geographic location 331-2. In these embodiments, the fourth computing device 323-4, the fifth computing device 323-5, and/or the sixth computing device 323-6 can receive computing resources from a second computing resource provider 322-2 that receives electricity from a second electrical provider 321-2.

In a similar way, the organization can include a seventh computing device 323-7, an eight computing device 323-8, and/or a ninth computing device 323-9 that are geographically located within the third geographic location 331-3. In these embodiments, the seventh computing device 323-7, the eight computing device 323-8, and/or the ninth computing device 323-9 can receive computing resources from a third computing resource provider 322-3 that receives electricity from a third electrical provider 321-3. In some embodiments, each of the geographic locations can include multiple computing resource providers and/or multiple different electrical providers. For example, the second geographic location 331-2 can include a particular computing resource provider and electrical provider on the East Coast and a different computing resource provider and a different electrical provider on the West Coast.

As described herein, an emissions report can be generated for each of the plurality of computing devices (e.g., first computing device 323-1, second computing device 323-2, third computing device 323-3, fourth computing device 323-4, fifth computing device 323-5, sixth computing device 323-6, seventh computing device 323-7, eight computing device 323-8, ninth computing device 323-9, etc.). As described herein, the emissions report can be generated utilizing the quantity and time the corresponding computing device utilized the computing resources, the type of computing resources utilized, and/or the emissions statistics of the corresponding electrical provider. In these embodiments, an emissions report can be generated for the organization based on the individual emission reports for the plurality of computing devices.

In some embodiments, the method 100 can be applied to the system 330. For example, a computing device (e.g., computer, SyaaS, SaaS, etc.) can identify a plurality of computing devices (e.g., first computing device 323-1, second computing device 323-2, third computing device 323-3, fourth computing device 323-4, fifth computing device 323-5, sixth computing device 323-6, seventh computing device 323-7, eight computing device 323-8, ninth computing device 323-9, etc.) associated with the organization.

In these embodiments, the computing device can determine a computing resource usage value for each of the plurality of computing devices. For example, the computing resource usage value can refer to a quantity of compute transactions between each of the computing devices and corresponding computing resource provider (e.g., first computing resource provider 322-1, second computing resource provider 322-2, third computing resource provider 322-3).

In these embodiments, the computing device can determine a corresponding computing resource provider for each of the plurality of computing devices. For example, the computing device can determine that the first computing device 323-1 is receiving a SyaaS and/or a SaaS from the first computing resource provider 322-1, the fourth computing device 323-4 is receiving a SyaaS and/or a SaaS from the second computing resource provider 322-2, and the seventh computing device 323-7 is receiving a SyaaS and/or a SaaS from the third computing resource provider 323-3.

In some embodiments, the computing device can determine the computing resource usage value from each of the plurality of computing resource providers. For example, the quantity of compute transactions over a period of time can be determined between the first computing device 323-1 and the first computing resource provider 322-1. In this example, each of the compute transactions can include time stamp data to identify the day and/or time that each compute transaction was performed.

In these embodiments, the computing device can calculate a power usage value for each of the corresponding resource providers by the plurality of computing devices. As describe herein, each of the computing resource providers can utilize a different electrical provider that generates electricity with different environmental impacts (e.g., different emission statistics, etc.). In these embodiments, the computing device can determine a quantity of compute transactions over different periods of time and determine a quantity of electrical power utilized by the corresponding resource provider. Further, the quantity of electrical power over the different periods of time can be utilized to determine emission values utilizing the emission statistics of the corresponding electrical provider.

For example, the power usage value for the first computing device can be calculated by the computing device. In this example, the quantity of compute transactions with between the first computing device and the first computing resource provider 322-1 can be determined for a period of time. The quantity of compute transactions can be utilized to determine the quantity of electrical power utilized by the first computing resource provider 322-1 during the period of time. In this way, the emission statistics for the period of time from the first electrical provider 321-1 can be utilized to calculate the emissions generated to provide the electricity to the computing resource provider 322-1 to perform the compute transactions with the first computing device 323-1. This can be performed for each of the plurality of computing devices with the corresponding computing resource providers and corresponding electrical providers.

In these embodiments, the computing device can generate a usage recommendation for the organization based on the emission report for the organization. For example, the usage recommendation can be directed to the overall organization. In this example, the usage recommendation can include recommendations to utilize more or less computing resources within a particular geographic location. For example, the emission statistics for the first geographic location 331-1 can include a relatively higher emissions per compute transaction compared to the second geographic location 331-2.

In another example, the usage recommendation can alter time windows or time periods for performing the compute transactions. In this example, an optimal time window or time period can be a period of time where the quantity of emissions is lower than a different time period. For example, executing a particular compute transaction during a first time period can result in a greater quantity of emissions compared to executing the same particular compute transaction during a second time period. In this example, the quantity of electricity needed to execute the compute transaction can be the same, but the emission statistics from the electrical provider can be different for the first time period and the second time period.

In some embodiments, the usage recommendation can be specific to particular computing devices of the plurality of computing devices. For example, the first computing device 323-1 can receive a usage recommendation that is specific to the usage of the first computing device 323-1. For example, the first computing device 323-1 can perform compute transactions that are different than the second computing device 323-2. Thus, even though the first computing device 323-1 and the second computing device 323-2 utilize the same first computing resource provider 322-1, the first computing device 323-1 and the second computing device 323-2 may utilize a different quantity of compute transactions. In this example, the first computing device 323-1 can receive a usage recommendation to perform particular functions with relatively high compute transactions (e.g., machine learning models, etc.) at a designated time or designated time period.

In some embodiments, the first computing device 323-1 can receive settings changes through the usage recommendation. For example, the usage recommendation can alter settings of the first computing device 323-1 such that particular compute transactions are performed during the designated time or designated time period even when the compute transaction is requested by the user of the first computing device 323-1 during a different time period. In this example, the first computing device 323-1 can receive a command from a user to perform a particular compute transaction at a first time. In this example, the particular compute transaction can utilize a machine learning model provided by the first computing resource provider 322-1. In this example, the first time may not be within a designated time period. In this example, the first computing device 323-1 may wait until the designated time period to send the particular compute transaction to the first computing resource provider 322-1 in order to lower emissions (e.g., scope 2 emissions, etc.) generated by the first computing device 323-1.

In some embodiments, the usage recommendation can provide settings changes and/or usage changes across the organization to lower the quantity of emissions and/or costs to the organization associated to emissions. In other embodiments, a usage recommendation can be generated for each of the plurality of computing devices. In this way, the organization can identify settings and/or usage patterns that can be altered in order to lower emissions and/or costs. In addition, the individual computing device users can be notified of setting changes and/or usage pattern changes that are specific to their geographic location.

FIG. 4 is an example of a computing device 490 for generating usage recommendations for computing devices based on computing device energy consumption in accordance with one or more embodiments. As illustrated in FIG. 4, the computing device 490 can include a memory 494 and a processor 492 for generating usage recommendations for computing devices based on computing device energy consumption, in accordance with the present disclosure.

The memory 494 can be any type of storage medium that can be accessed by the processor 492 to perform various examples of the present disclosure. For example, the memory 494 can be a non-transitory computer-readable medium having computer-readable instructions (e.g., executable instructions/computer program instructions) stored thereon that are executable by the processor 492 for generating usage recommendations for computing devices based on computing device energy consumption in accordance with the present disclosure.

The memory 494 can be volatile or nonvolatile memory. The memory 494 can also be removable (e.g., portable) memory, or non-removable (e.g., internal) memory. For example, the memory 494 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 494 is illustrated as being located within computing device 490, embodiments of the present disclosure are not so limited. For example, memory 494 can also be located internal to another computing resource (e.g., enabling computer-readable instructions to be downloaded over the Internet or another wired or wireless connection).

The processor 492 may be a central processing unit (CPU), a semiconductor-based microprocessor, and/or other hardware devices suitable for retrieval and execution of machine-readable instructions stored in the memory 494.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
identifying, by a computing device, a plurality of computing devices associated with an organization;
determining, by the computing device, a computing resource usage value for each of the plurality of computing devices;
determining, by the computing device, a corresponding computing resource provider for each of the plurality of computing devices;
calculating, by the computing device, a power usage value for each of the corresponding computing resource providers by the plurality of computing devices;
determining, by the computing device, an emission value for the organization based on the power usage value for each of the corresponding computing resource providers and emission statistics for each of the corresponding computing resource providers; and
generating, by the computing device, a usage recommendation for the organization to alter the emission value based on the computing resource usage value for each of the plurality of computing devices and the corresponding computing resource provider for each of the plurality of computing devices.

2. The method of claim 1, wherein the method includes providing, by the computing device, a personal usage recommendation to each of the plurality of computing devices based on an individual impact to the emission value.

3. The method of claim 2, wherein the method includes altering, by the computing device, settings of the plurality of computing devices to alter the computer resource usage values.

4. The method of claim 3, wherein the method includes altering, by the computing device, settings of the plurality of computing devices to alter a time window for performing particular computing tasks to alter the computer resource usage values during the time window.

5. The method of claim 1, wherein the method includes determining, by the computing device, time stamp data of the computing resource usage values for each of the plurality of computing devices.

6. The method of claim 5, wherein the time stamp data indicates a time when the computing resource usage values were performed by each of the computing devices.

7. The method of claim 6, wherein the emission statistics for each of the corresponding computing resource providers includes a quantity of emissions released by an electrical provider for a plurality of time windows.

8. The method of claim 7, wherein the method includes:
identifying, by the computing device, the computing resource usage values for the plurality of time windows based on the time stamp data; and
generating, by the computing device, an individual usage recommendation for each of the plurality of computing devices to increase future computing resource usage values to include future time stamp data within time windows of the plurality of time windows that include a quantity of emissions below threshold quantity of emissions.

9. A non-transitory computer-readable medium storing instructions executable by a processing resource to cause the processing resource to:
determine a computing resource usage value for each of a plurality of computing devices of an organization over a period of time;
determine a corresponding computing resource provider for each of the plurality of computing devices;
determine an electrical provider for the corresponding computing resource providers;
calculate a power usage value for each of the corresponding computing resource providers by the plurality of computing devices during the period of time utilizing the computing resource usage value and an electrical usage per computing resource usage for the electrical provider;
determine an emission value for the organization based on the power usage value for each of the corresponding computing resource providers and emission statistics for each of the electrical providers of the corresponding computing resource providers; and
generate a usage recommendation for the organization to lower the emission value based on the computing resource usage value for each of the plurality of computing devices and the corresponding computing resource provider for each of the plurality of computing devices.

10. The non-transitory computer-readable medium of claim 9, comprising instructions to determine an emission profile and a cost profile for the electrical providers during the period of time.

11. The non-transitory computer-readable medium of claim 10, comprising instructions to determine a first plurality of time windows where the emission profile or the cost profile is above a threshold and a second plurality of time windows where the emission profile or the cost profile is below the threshold.

12. The non-transitory computer-readable medium of claim 11, wherein the instructions to generate the usage recommendation to increase a quantity of computing resource usage value for each of the plurality of computing devices during the second plurality of time windows and decrease a quantity of computing resource usage value for each of the plurality of computing devices during the first plurality of time windows.

13. The non-transitory computer-readable medium of claim 9, comprising instructions to generate a recommendation for paying carbon taxes based on the emission value for the organization.

14. The non-transitory computer-readable medium of claim 9, wherein the computing resource usage value identifies a quantity of compute transactions between a computing device of the plurality of computing devices and a particular computing resource provider.

15. The non-transitory computer-readable medium of claim 14, including instructions to determine an electrical usage for each of the quantity of compute transactions between the computing device of the plurality of computing devices and the particular computing resource provider.

16. The non-transitory computer-readable medium of claim 9, including instructions to identify a geographical location of the plurality of computing devices and determine the electrical provider for the corresponding computing resource providers based on the geographical location.

17. A computing device, comprising:
a processing resource; and
a memory resource storing non-transitory machine-readable instructions to cause the processing resource to:
identify a plurality of computing devices associated with an organization, wherein the plurality of computing devices are located in different geographical locations;
determine a plurality of computing resources providers that are utilized by the plurality of computing devices;
determine a quantity of compute transactions between the plurality of computing resources and the plurality of computing devices to determine a computing resource usage value for each of the plurality of computing devices of an organization over a period of time;
determine an electrical provider for each of the plurality of computing resource providers;
calculate a power usage value for each of the plurality of computing resource providers utilized by the plurality of computing devices during the period of time utilizing the quantity of compute transactions and an electrical usage per compute transaction;
determine an emission value for the organization based on the power usage value for each of the plurality of computing resource providers and emission statistics for each of the electrical providers of the plurality of computing resource providers; and
generate a usage recommendation for the organization to lower the emission value based on the computing resource usage value for each of the plurality of computing devices, wherein the usage recommendation includes instructions to alter a time period for executing future compute transactions between the plurality of computing devices and the plurality of computing resource providers.

18. The computing device of claim 17, wherein the usage recommendation includes instructions for executing the future compute transactions during a time period to lower a financial cost to the organization.

19. The computing device of claim 17, comprising instructions to cause the processing resource to generate financial cost trends and emission trends for the organization based on historical data associated with the plurality of computing devices.

20. The computing device of claim 17, comprising instructions to cause the processing resource to:
determine a type of transaction for the plurality of transactions;
calculate a power usage value for the type of transaction for the plurality of transactions; and
generate a transaction report that identifies a type of transaction to alter based on the power usage value.
